(19) United States
(12) Patent Application Publication
(10) Pub. No.: US 2003/0186067 A1
(43) Pub. Date: Oct. 2, 2003

(54) Rolled metal substrate coated with organic based varnish, and method for applying such varnish to surfaces of rolled metal

(76) Inventors: Keith Redford, Hagan (NO); Christian Simon, Oslo (NO)

Correspondence Address: DENNISON, SCHULTZ & DOUGHERTY, 1745 JEFFERSON DAVIS HIGHWAY, ARLINGTON, VA, 22202, US

(21) Appl. No.: 10/311,337

(22) PCT Filed: Jul. 5, 2001
(86) PCT No.: PCT/NO01/00288

(30) Foreign Application Priority Data
Jul. 5, 2000 (NO) 20003463

(51) Int. Cl. B32B 15/08; B32B 15/04

(52) U.S. Cl. 428/457

(57) ABSTRACT

Rolled metal substrate of aluminium, aluminium alloys or steel with a layer of an organic based and preferably clear and glossy lacquer/varnish. The lacquer/varnish or gel-coat comprises controlled amounts of inorganic polymer particles mainly with a size mainly in the range 1-100 nm, the particles being able to form a three-dimensional network that is independent of the organic network of the lacquer or with bondings to this network. The polymer particles are typically a reaction product obtained by hydrolysis and condensation reactions of monomer compounds chosen among the following groups: i) M(OR)ₙ, or ii) R′-M(OR)ₙ, where M is a metal ion, and R is an organic group chosen among alkyl, alkenyl, aryl or combination of such groups with from 1 to 8 carbon atoms, R′═R or R—X, where X is an organic group like e.g. amine, carboxyl or isocyanate, and n is an integer between 1 and 6. Alternatively the polymer particles may comprise natural or synthetic clay based powders or combinations of such powders. The invention further relates to a utilization of such a lacquer/varnish for coil coating of rolled surfaces of aluminium, aluminium alloys or steel.

The present invention relates to a metal substrate of aluminium or steel, protected by a layer of modified organic lacquer/varnish and utilization of au organic based lacquer/varnish based on organic based gel-coats for coil coating of rolled aluminium or steel.

### BACKGROUND

Under anodizing of aluminium a very hard and scratch resistant surface of album oxide is formed The process however has several significant limitations. There are limitations as to the types of aluminium alloys that are anodizable. When manganese is an element of the alloy being incorporated in the aluminium oxide, the transparent oxide becomes discoloured and brown. At high concentrations of silicon, the oxide becomes gray and the intensity of the colours is dependent of the concentration of the elements. Furthermore the productivity of continuous anodizing lines is low. The line velocity of thick oxide layers, layers of ca. 20 μm, is about 5-10 m/min., while continuous lacquering (coil coating) varies in speed from 50 to 200 m/min.

Anodized album has very limited bendability, and the oxide will form cracks already at a high bending radius. Today this implies that anodizing is used only for products that have been given their final, bent shape. The anodization thus takes place in plants handling separate products, with even lower productivity than continuous lines.

A coating of a different type is known from PCT patent application PCT/NO98/00301, consisting of two lacquers produced from a of 2 polymers, of which the first is produced by condensation polymerization of phenol and formaldehyde, and the second of a heat hardening amine polymer. The coating obtains a micro hardness of 40 Kp/mm² at a load of 8.2 g in 30 seconds at 25° C. This lacquer system has a distinct yellow colour and its weather resistance is poor due to the phenolic content of the polymer.

Thus, there exists a need for hard coatings &hat are scratch resistant and may be applied continuously and without the problems related to the anodizing process.

It is previously known to manufacture coatings in the form of lacquers that in dried form are purely organic and which have the advantage or the characteristic over lacquers with an inorganic content, that they as clear lacquers may be manufactured with significantly more glossy surfaces. It is however a disadvantage with these lacquers and coatings that their wear resistance are not particularly good due to their inability to include conventional fillers that would change their appearance.

SE patent application No. 9603174-5 (KompoPigment Ltd.) presents the manufacture of aqueous paintings and lacquers with a content of polymers, in which to improve the wear resistance of the painting or the lacquer, particles of SiO₂ are added, which particles have a size up to 150 nm preferably no more than 100 nm, in a weight content of maximum 65% of the dry weight of the dispersion

EP A1 0 555 052 describes a fluid mixture comprising an acryl monomer, silica particles and at least one initiator for ultraviolet curing of said mixture, as well as a component to inhibit decomposition of the mixture caused by the ultraviolet radiation. The silica particles of said mixture are typically of a size 15-30 nm. The object of said mixture is the manufacture of transparent organic based coatings that are wear and weather resistant. The patent is limited in its scope to one organic system, namely acryl, which in its basis is a mixture of a monomer with silica particles, not an organic resin.

From a.o. EP 0 786 499 is known the fact that wear resistant coatings may be formed from a composition consisting of multifunctional organo-metallic components (designated A) that is combined with an organic monomer which includes several functional groups (designated B). For this known method it has been shown that a strong binding is formed between the organo-metallic components and the organic monomer prior to polymerization/hardening, cfr. page 4, line 29-30. The subsequent polymerization yields a network comprising a combination of the A and B components in which the inorganic components are chemically bound to organic polymerized in a single common network

From DE 199 24 644 is known a method for the manufacture of a lacquer comprising nano-particles. The method comprises in-situ formation of the particles through hydrolysis and condensation of metal oxides, so-called sol-gel synthesis. The objective with performing the manufacture in-situ as suggested is to control the particle size so that agglomeration does not lead to larger particles than desired. This publication too concentrates on systems leading to a single, common network of matrix and nano-particles, cfr. e.g. column 2, line 63-66.

It is worth-noticing that aqueous paintings and lacquers are dispersions of the relevant polymer, which after removal of the solvent (actually dispersion agent) builds a protective layer. This means that the polymer is not present in the form of an actual solution. When the water evaporates and the polymer settles on a surface, the many minor polymer particles “float together” and builds a continuous, protective coating. Even if this takes place in a degree that is good enough for many purposes, aqueous paintings and lacquers still provide a lot weaker protection than organic based lacquers and solvents, where the polymer prior to application is completely dissolved, and during the hardening builds a continuous protective layer with a basis in the single molecules of the polymer.

Due to the above mentioned chemical difference between aqueous and organic based lacquers and paintings, it is not possible just to apply a method like the one described m said Swedish patent to lacquers based on organic solvents.

It is known to add inorganic particles of a size of several micrometers (μm) to aqueous or organic based lacquer systems (so-called fillers or pigments). This modification may affect the wear resistance properties somewhat, but is rather used to change the appearance (like the colour) or to increase the weight of the lacquer.

There is no known method for the protection of surfaces of aluminium and steel, particularly rolled aluminium and steel that fulfills all the requirements regarding wear resistance etc and has a simple method of application.

Objective

It is an object with the present invention to provide a lacquer and a coating that is suited to provide rolled surfaces of aluminium and/or steel a protective layer that is hard, wear resistant, weather resistant, smooth, glossy and clear.

It is a secondary object with the invention to modify the wear resistance properties of clear, organic lacquer systems without changing their other properties like clearness and glossiness.

The Invention

The invention relates to a rolled metal substrate of aluminium, aluminium alloys or steel with a layer of an organic based and preferably clear and glossy lacquer/varnish characterized by the features defined by the characterizing part of claim 1.

Preferred embodiments of the metal substrate according to the invention is defined by the claims 2-9.

The invention further relates to the utilization of an organic based and preferably clear and glossy lacquer/varnish with a high wear resistance, as defined by claim 10.

Preferred embodiments of the utilization according to the invention is defined by claims 11-16.

The core of the invention may be expressed as with regard to coil coating of rolled surfaces of aluminium or steel, to use a lacquer/vanish of the previous described type, said lacquer/varnish being provided with particles of nano size, i.e particles with a size mainly in the range 1-100 nm. Such particles cannot just be “added” in the form of particles as such, their provision need to take place through one or more of the alternative methods by which the particles are formed through chemical reactions taking place in situ or mediately prior to their addition to the base component of the lacquer. There are three principally different methods for preparing such lacquer systems, in the following also designated as model 1, model 2 and model 3 respectively. The methods are briefly explained for the sake of completion even though the methods as such are not a subject matter of this invention, but are covered of the Norwegian patent application No. 2000 3462 with the same priority date as the present application.

An important aspect is that particles of the relevant type and size are not present as discrete particles in a lacquer matrix. The particles will rather form their own inorganic/organic network that comes in addition to the organic network of the lacquer. These two networks will be present side by side independent of each other, but they may to a larger or lesser degree be attached to one another through cross-linked bondings. The degree of network formation is to some extent dependent also by which of the three manufacturing model that is chosen and by the particle size, and cannot be predicted entirely on a theoretical basis. The invention is not, however, limited to certain degrees of network formation or to any certain mechanism for the formation of such networks.

The practical implication of two principally independent networks is a.o. that the coating formed not only is strong, but in addition is more fexible than many other lacquers/coatings, included such where the nano-particles are tied into a network with the lacquer's organic resin. Coatings that are less flexible will soon experience crack formation if put on top of materials that themselves are flexible/movable. Rolled aluminium or steel which are wound on to big coils are typical examples of utilizations where it is vital that the finished hardened lacquer is flexible if it shall be able to provide a lasting protection to the metal.

A lacquer/varnish suited the metal substrate and the utilization according to the invention, may be manufactured by a first method, hereinafter designated model 1, by which first preparing a particle dispersion (sol) by partial hydrolysis of one or more inorganic polymer particles of the kind previously stated. A solvent compatible with the solvent of the lacquer to be modified is used for this purpose. Thereafter the mentioned sol, at this stage comprising nano-particles of desired size, is added to the lacquer. It is preferred also to modify the surface of the particles through a treatment that may comprise adsorption of polymers, reactions with a silane, a zirconate, a zircoaluminate, an orthotitanate, an aluminate or a combination of such treatments.

Chemically there are two steps in the preparation of a sol from metal-organic compounds according to some of the embodiments, model 1 and 2, of the invention. A solution containing monomer compounds of the formula M(OR)ₙ or R′-M(OR)ₙ is used as a starting solution. In the formula M(OR)ₙ, M is a metal ion and R is an organic group chosen among alkyl, alkenyl, aryl or combinations av these with from 1 to 8 carbon atoms. In the formula R′-M(OR)ₙ, R′═R or R′═R—X where X is an organic group like e.g. amine, carboxyl or isocyanate. It is preferred that R is a simple alkyl with 1-4 carbon atoms. The index is an integer from 1 to 6 dependent upon the valency of the metal ion.

The first step is hydrolysis of the metal alkoxide, where alkoxide ligands are replaced by hydroxyl groups:

M-OR+H—OH M-OH+ROH

The second step is condensation, where hydroxyl groups either may react with hydroxyl or alkoxy groups from other metal centres, forming M-O-M bonds and either water or alcohol.

M-OH+HO-M M-O-M+H₂O

or

M-OR+HO-M M-O-M+ROH

The course of reaction is principally the same if started from the compound R′-M(OR)ₙ, as the group R′ does not participate in the hydrolysis or condensation reactions.

The resulting solution consists of inorganic polymer particles dispersed in a solvent.

A preferred variant includes the addition of a compound with functional OH-groups, like e.g. butyldiglycol or ethylhexanol during the hydrolysis/condensation step. This has shown the formation of a stable sol that is compatible with lacquers/gel-coats.

E.g. when all acrylic lacquer is to be modified, it is preferred to add butyldiglycol (BDG) during the hydrolysis/condensation of γ-aminopropyltriethoxysilane (-APS). A BDG-molecule will be able to substitute an ethoxy-group of -APS(—ODGB). —ODGB is probably significantly more difficult to substitute by —OH compared to the case of —OEt due to possible interactions between the —ODGR substituent and the Si-atom. Such interactions are not significant between OEt and the Si atom. Generally it is to be expected that larger alcohol residues are more difficult to substitute by —OH due to the fact that a larger alcohol molecule subsequent to a possible hydrolysis remains for a longer period of time in the vicinity of the silane than a smaller alcohol molecule does. As a consequence the opposite reaction (condensation between Si—OR and EtOR to SiOR+H₂O) is more likely for larger alcohol molecules than for smaller. It is decisive for the particle formation that only two sites on the Si-atom are available for hydrolysis/condensation. Three or four sites with possibility of hydrolysis/condensation leads to formation of large agglomerates which are normally difficultly soluble in organic solvents. As an alternative to the intramolecular catalysed hydrolysis/condensation, an intermolecular variant is also possible. In this case the amino group of a silane molecule in the vicinity of another silane molecule catalyses the hydrolysis/condensation of the latter silane molecule. This way nano-particles compatible with the acrylic lacquer are formed.

The lacquer/varnish suited for the metal substrate and the utilization according to the present invention may be prepared by a different variant, hereinafter designated model 2. According to this variant a controlled amount of inorganic compounds of the mentioned type is added to an existing commercial clear lacquer or an existing commercial gel-coat. To obtain in-situ formation of particles within the desired size it is necessary to establish chemical conditions ensuring a correct balance between the kinetics of the two required reactions, namely the condensation reaction and the hydrolysis. While the condensation reaction provides for the formation of polymer chains polymerizes) from monomer (single) molecules, the hydrolysis provides for a polycrystalline precipitation or oxohydroxide precipitation taking place in contact with the components of the lacquer. A suitable choice of metal-organic compound combined with exchange (replacement) of alkoxide groups with strong ligands, will slow down the hydrolysis reactions compared to condensation reactions, which will ensure that said chains do not become too long, but swill stay within a range herein denoted as oligomers. In practice this means that the particles will often be only of a few nm in size, most typically smaller than 10 nm. It is preferred that the particles are smaller 30 nm, as that ensures that the lacquer remains bright.

In the same manner as for model 1 it is preferred additionally to modify the surface of the particles through a treatment that may comprise adsorption of polymer, reaction with a silane, a zirconate, a zircoaluminate, an orthotitanate, an aluminate, or a combination of such treatments.

According to a third variant of the preparation, model 3, a powder of agglomerated particles of the above mentioned type is first established. The agglomerates of the powder are so loose that they may be broken down to particles of nano size with a mechanical treatment, a chemical treatment or a combination of such treatments. This implies that clay based materials represent an alternative that may be used for model 3. In the same manner as for model 1. it is preferred additionally to modify the surface of the particles through a treatment that may comprise absorption of polymer, reaction with a silane, a zirconate or a combination of such treatments.

Common for the three mentioned embodiments/variants is that it is possible to start from existing lacquers, preferably glossy clear lacquers based on organic solvents, and to change their properties by means of a treatment with inorganic polymer particles, so that the resulting lacquer incorporates particles of nano size. These particles will as mentioned form a three-dimensional network that comes in addition to the organic network of the lacquer itself, and contributes to providing the lacquer an unsurpassed wear resistance compared to ordinary organic based lacquers, while the finished hardened lacquer still maintains its flexibility and does not become brittle. The additional network comprising the inorganic particles is principally independent of, but may be partly bonded to, the organic network of the lacquer.

Generally coatings with a thickness between 1 and 50 μm are made, depending on the coating method and the properties of the substrate. Due to the improved properties of the coating made according to the invention, such as high wear resistance, the coating thickness may be lower, e.g. in the range 1 to 10 μm.

With addition of a controlled amount of inorganic polymer particles is meant an amount that is sufficient to allow the particles to form such a network as described above. The amount required will have to be determined in each separate case in dependence of particle size, particle type and type of lacquer. In general the amounts of inorganic particles will stay between an interval of from 0.5 to 50% by weight calculated on a basis of the laquer in question. At concentrations close to or below the lower of said limits the particles will only to a limited degree be able to form the network necessary to obtain the desired improvement of the lacquer's properties. At concentrations above said upper limit there is a risk that the particles will negatively affect the lacquer's appearance, so that it will no longer appear as glossy; smooth and clear as prior to the particle addition.

The metal ion M according to the invention is chosen among a series of metals, such as ziconium, aluminium, titanium, silicon, magnesium, chrome, manganese, iron, cobalt and several others. Through research it has been found that compounds where the metal ion is zirconium, aluminium, titanium, silicon or a combination of these are very well suited for the purpose, and these metals therefore constitute preferred embodiments of the metal ion according to the invention. The organic part R of the molecule is an alkyl, an alkenyl, an aryl or a combination of these groups, of practical reasons limited in size to groups comprising a maximum of 8 carbon atoms. It is however preferred that R does not have more than 4 carbon atoms, and more preferred that it is a simple alkyl like methyl, ethyl, propyl or butyl.

Many different organic types of lacquers are suited for the purpose of the invention, and the type is largely decided by the area of use. To mention the most important ones, acrylic lacquers, epoxy lacquers, polyester lacquers, polyurethane lacquers, polyamide lacquers and polycarbonate lacquers, may all be used as a the base lacquer according to the invention.

Below the invention is further elaborated through a number of test examples for some of the manufacturing methods according to the invention. Utilization related to steel surfaces are not included, but it should be emphasized that steel in principle is similar to aluminium, though the adhering properties and hardness are somewhat different for these materials.

### EXAMPLE 1

A commercial clear epoxy lacquer VS 150 from Valspar, USA was modified according to model 2 and used for coating of aluminium sheets.

The eopxy lacquer was a one component lacquer comprising both the resin and a cross-linker.

Modification: 20 ml of a mixture of 61 g tetraethoxy-orthosilane (TEOS) from Sigma Aldrich, CH, 200 g butanol and 121 g aluminium sec-butoxide from Sigma Aldrich, CH was added dropwise with about 2 second intervals between each drop to 40 ml of lacquer under vigorous agitation (800 rpm). The entire process lasted about 40 minutes.

Applying: After 5 minutes of agitation the lacquer was applied to an aluminium sheet by “bar coating” (rod number 26). Immediately after application the sheet was placed in connvection oven holding the temperature of the aluminium sheet (“Peak Metal Temperature” PMT) at 250° C. The sheet was thereafter removed from the oven and cooled in cold water. The coated layer was measured to 8 μm.

Testing: The wear resistance properties were tested by means of a hardness pen of type Brichsen, Germany. The method consists of making a scratch with the hardness pen. The force applied being controlled by a spring. The hardness value correlated to the force is read from the pen. Parallel readings showed that the force on the sheet covered by the modified lacquer was beyond 1 N, while the force on the sheet covered by the non-modified lacquer was below 0.2 N.

### EXAMPLE 2

A commercial clear acrylic lacquer (SZ-006 from Rhenania, Germany) was modified according to model 2 and used for coating aluminium sheets.

The acrylic lacquer was a one-component lacquer containing both resin and cross-linkers.

Modification: 4.7 g of tetra isopropyl orthotitanate from Sigma Aldrich, CH was added to 12.9 g methacrylic acid under agitation. After 15 minutes of agitation the solution was added to 26.4 lacquer under agitation.

Application: After 5 minutes of agitation the lacquer was applied to an aluminium sheet using “bar coating” (rod No. 26). Immediately thereafter the sheet was placed in a convection oven holding the temperature of the aluminium sheet (“Peak Metal Temperature” PMT) at 241° C. The sheet was thereafter removed from the oven and cooled in cold water. The coated layer was measured to 8 μm.

Testing:

Wear resistance.

The wear resistance properties were tested by means of a Universal Wear Testing Machine from Eyre/Biceri. One of the lacquered sheets was strapped to the apparatus. A cotton pole was attached to the movable part and placed on the lacquered sheet with a constant weight of 588 g (3× load) and the apparatus was started. The number of turns was automatically counted. After 20 turns the surface of the sheet was metalized and observed.

The number of die lines on the part coated with non-modified lacquer was comparatively large. On the part coated with modified lacquer the die lines were barely visible. On an empiric scale from 1 to 6 where 1 is best (no die lines) and 6 worst (many die lines) the modified lacquer got value 2 and the non-modified lacquer got value 3.

Clearness

The lacquer was optically clear. The clearness of a lacquer may be quantified by measuring the brightness (RD/20). The brightness of the modified lacquer had a value of 1793, which was in the magnitude of the brightness of the non-modified lacquer (1773).

### EXAMPLE 3

The same commercial lacquer as used for example 2 was modified according to model 1 and used for coating aluminium sheets.

Modification: 11.34 g of an alcoholate solution of titanium propoxide from Sigma Aldrich, CH was added to 7.74 hexanoic acid under agitation. Thereafter 1 g of distilled water was added under agitation. After 15 minutes of agitation, 10 g of the resulting sol was added to 0.165 g-aminopropyl triethoxysilane under agitation 1 g of the resulting mixture was thereafter added to 10 g lacquer under agitation.

Application: After 5 minutes of agitation the lacquer was applied to an aluminium sheet by “bar coating” (rod NO. 26). Immediately thereafter the sheet was placed in a convection oven, holding the temperature of the aluminium sheet (“Peak Metal Temperature” PMT) at 241° C. The sheet was thereafter removed from the oven and cooled in cold water. The coated layer was measured to 8 μm.

Characterizing and Testing

Sol Particle Size

The sol particle size was determined by means of the light scattering principle. A commercial instrument, “Zetasizer 3” from Malvern, UK, was used to determine the size distribution. The size distribution was sharp and the average particle size was 5 nm.

Wear Resistance Properties

The wear resistance properties were tested by means of a Universal Wear Testing Machine from Eyre/Biceri, as for example 3. The constant weight was 588 g (3× load). The number of die lies on the part coated with non-modified lacquer was comparatively large. On the part coated with modified lacquer the die lines were barely visible. On an empiric scale from 1 to 6 where 1 is best (no die lines) and 6 worst (many die lines) the modified lacquer got value 2 and the non-modified lacquer got value 3.

Clearness.

The lacquer was optically clear. The clearness of a lacquer may be quantified by measuring diffuse transmission. This may be performed e.g. by using a clear glass plate as a substrate for the lacquer. First the diffuse transmmission is measured on the glass plate alone. Thereafter the lacquer is applied to the glass plate and the diffuse transmission is measured again. The change in diffuse transmission after the application of the lacquer is a good measure of the clearness of the lacquer (provided that the interface between lacquer and the glass plate does not contribute significantly to the light scatting). The measurements was done with an apparatus according to the DIN 5036 standard.

Diffuse transmission of the clear glass pie was measured to 0.5%. The non-modified lacquer was applied to the glass plate (coating layer of 5 μm). The diffuse transmission was thereafter measured to 1.5%. Diffuse transmission for the modified lacquer was measured below 6%.

### EXAMPLE 4

The commercial lacquer used for example 2 was modified according to model 1 and applied to aluminum sheets.

Modification: 4.7 g of tetra isopropyl orthotitanate from Sigma Aldrich, CH was added to 15.3 g pentanoic (valeric) acid under agitation. Thereafter 0.45 g of distilled water was added under agitation. After 15 minutes agitation of this sol, 10 g sol was added to 10 g lacquer under agitation.

Application: After 5 minutes of agitation the lacquer was applied to an aluminium sheet by “bar coating” (rod NO. 26). Immediately thereafter the sheet as placed in a convection oven, holding the temperature of the aluminium sheet (“Peak Metal Temperature” PMT) at 241° C. The sheet was thereafter removed from the oven and cooled in cold water. The coated layer was measured to 8 μm.

Characterizing and Testing

Sol Particle Size

The sol particle size was measured by means of “Zetasizer 3” from Malvern, UK. The size distribution was sharp and the average particle size was 3 nm.

Wear Resistance Properties.

The wear resistance properties were tested by means of a Universal Wear Testing Machine from Eyre/Biceri, as for example 3, The constant weight was 980 g (5× load). The number of die lines on the part coated with non-modified lacquer was comparatively large. On the part coated with modified lacquer the die lines were barely visible. On an empiric scale from 1 to 6 where 1 is best (no die lines) and 6 worst (many die lines) the modified lacquer got value 3 and the non-modified lacquer got value 6.

Clearness

The lacquer was optically clear. The clearness of a lacquer may be quantified by measuring the brightness (RD/20). The brightness of the modified lacquer had a value of 1693, which was comparable to the brightness of the non-modified lacquer (1773).

### EXAMPLE 5

The same commercial lacquer as used for example 2 was modified according to model 3 and applied to aluminium sheets.

Modification: 10 g of a commercial titanium oxide from Nanophase, USA, comprising titania particles with an average size of 20 nm (20% by weight in an organic solvent) was added to 10 g lacquer under agitation.

Application: After 5 minutes of agitation the lacquer was applied to an aluminium sheet by “bar coating” (rod NO. 26). Immediately thereafter the sheet was placed in a convection oven, holding the temperature of the aluminium sheet (“Peak Metal Temperature” PMT) at 241° C. The sheet was thereafter removed from the oven and cooled in cold water. The coated layer was measured to 8 μm.

Testing: The wear resistance properties were tested using a “taber abraser” like for example 3. The weight loss measured for the sheet coated with the non-modified lacquer was significantly larger than the weight loss of the sheet coated with the modified lacquer.

### EXAMPLE 6

A commercial clear epoxy lacquer was modified according to model 3 and applied to aluminum sheets.

The epoxy lacquer was a one-component lacquer comprising both the resin and the cross-linker.

Modification: 9 g of a commercial bohemite powder from Condea Chemi was added to 20 g butanol under agitation. Thereafter 2.14 g of methacrylic acid was added under agitation. After 15 minutes of agitation the resulting sol was subjected to an ultrasound treatment (300 W 5 min., 50% pulse), and the sol was added to 10 g of lacquer under agitation.

Application: After 5 minutes of agitation the lacquer was applied to an aluminium sheet by “bar coating”. Immediately thereafter the sheet was placed in a convection oven, holding the PMT at 250° C. The sheet was thereafter removed from the oven and cooled in cold water.

Testing: The wear resistance properties were tested using a “taber abraser” like in example 3, the sheet being weighed before and after the test. The weight loss measured for the sheet coated with the non-modified lacquer was significantly larger than the weight loss of the sheet coated with the modified lacquer.

### EXAMPLE7

The same commercial lacquer as used for example 2 was modified according to model 3 and applied to aluminium sheets.

Modification: 3 g of a commercial titanium oxide powder from Tioxide, England was added to 6 g of butyldiglycol (BDG) and 8.33 g of 1-methoxy-1-acetoxypropane. The resulting dispersion was thereafter subjected to an ultrasound treatment for 17 minutes (200 W, 50% cycle). Thereafer the components of the lacquer was added in the following sequence and under agitation: 0.0072 g of PTSA solution, 7.2 g of HMMM Melamine resin solution, 9 g of blocked HDI isocyanate resin-solution and 29.4 g of acrylic resin solution.

Application: After 5 minutes of agitation the lacquer was applied to an aluminium sheet by “bar coating” (rod NO. 26). Immediately thereafter the sheet was placed in a convection oven, holding the temperature of the aluminium sheet (“Peak Metal Temperature” PMT) at 241° C. The sheet was thereafter removed form the oven and cooled in cold water. The coated layer was measured to 12 μm.

Testing

Wear Resistance Properties.

The wear resistance properties were tested by means of a Universal Wear Testing Machine from Eyre/Biceri, as in example 3. The constant weight was 588 g (3× load). The number of die lines on the part coated with non-modified lacquer was comparatively large. On the part coated with modified lacquer the die lines were barely visible. On an empiric scale from 1 to 6 where 1 is best (no die lines) and 6 worst (many die lines) the modified lacquer got value 1 and the non-modified lacquer got value 3.

Clearness

The lacquer was optically clear. The clearness of a lacquer may be quantified by measuring the brightness (RD/20). The brightness of the modified lacquer had a value of 1727, which was comparable to the brightness of the non-modified lacquer (1693).

### EXAMPLE 8

The same commercial lacquer as used for example 2 was modified according to model 1 and applied to aluminium sheets.

Modification: 60 g of -aminopropyltriethoxysilane (-APS) was added to 13.2 g of BDG and 15.18 g of distilled water. The sol was agitated moderately for 12 hours. 5 g of the sol was then added to 1 g of lacquer under moderate agitation.

Application: After 5 minutes of agitation the lacquer was applied to an aluminium sheet by “bar coating” (rod NO. 26). Immediately thereafter the sheet was placed in a convection oven, holding the temperature of the aluminium sheet (“Peak Metal Temperature” PMT) at 241° C. The sheet was thereafter removed from the oven and cooled in cold water. The coated layer was measured to a thickness of 7 μm.

Testing

Wear Resistance Properties

The wear resistance properties were measured by means of a “taber abraser” according to ISO standard D 4060-95. The method comprises exposing the lacquered surface to wear by means of a rubber wheel rotating on the sample. The number of turns is automatically registered (1000 turns), and the force is determined by a known weight (500 g). The sheets are weighed before and after the test. The weight loss of the sheet coated with non-modified lacquer was 12.37 mg, while the weight loss of the sheet coated with the modified lacquer was 1.22 mg.

The wear resistance properties were also tested by means of a Universal Wear Testing Machine from Eyre/Biceri, as in example 3. The constant weight was 980 g (5× load). The number of die lines on the part coated with non-modified lacquer was comparatively large. On the part coated with modified lacquer the die lines were barely visible. On an empiric scale from 1 to 6 where 1 is best (no die lines) and 6 worst (many die lies) the modified lacquer got value 1 and the non-modified lacquer got value 6.

### EXAMPLE 9

The same commercial lacquer as used for example 2 was modified according to model 1 and applied to aluminium sheets.

Modification: 100 g of a commercial silica sol from Nissan Chemicals, Japan, was added to 22.4 g γ-APS under slow agitation for 15.minutes. 10.2 g of the modified sol was thereafter added to a mixture of 3.3 g of -APS and 1.5 g of BDG under slow agitation. 5.1 g of the resulting composition was added to 1 g of lacquer under slow agitation.

Application: After 5 minutes of agitation the lacquer was applied to an aluminium sheet by “bar coating” (rod No. 26). Immediately thereafter the sheet was placed in a convection oven holding the temperature of the aluminium sheet (“Peak Metal Temperature” PMT) at 241° C. The sheet was thereafter removed from the oven and cooled in cold water. The coated layer was measured to a thickness of 7 μm.

Testing

Wear Resistance Properties.

The wear resistance properties were tested by means of a Universal Wear Testing Machine from Eyre/Biceri, as in example 3. The constant weight was 588 g (3× load). The number of die lines on the part coated with non-modified lacquer was comparatively large. On the part coated with modified lacquer the die lines were barely visible. On an empiric scale from 1 to 6 where 1 is best (no die lies) and 6 worst (many die lies) the modified lacquer got value 1 and the non-modified lacquer got value 3.

The tables below summarizes the types of lacquers/varnishes used and the results of the various hardness tests and brightness tests.

TABLE 1
Characterization of various types of lacquers prior to and
after their modification according to model No. 1.

| | | | | Scratch | | |
|---|---|---|---|---|---|---|
| | | | | test | Taber | |
| | | | | (1 = best, | abraser | |
| | | | | 6 = worst) | Weight | |
| Ex. | Type of | Model | Type of | 3X load | loss | Bright- |
| No. | lacquer | No. | modification | (see text) | (mg) | ness |
| 3 | Acrylic | | Non-modified | 3 | | |
| 3 | Acrylic | 1 | Ti | 2 | | |
| 4 | Acrylic | | Non-modified | 6* | | 1773 |
| 4 | Acrylic | 1 | Ti | 3* | | 1693 |
| 8 | Acrylic | | Non-modified | 6* | 12.37 | |
| 8 | Acrylic | 1 | Si | 1* | 1.22 | |
| 9 | Acrylic | | Non-modified | 3 | | |
| 9 | Acrylic | 1 | Si | 1 | | |

TABLE 2
Chracterization of various types of lacquers prior to and
after their modification according to model No. 2

| | | | | | Hard- | |
|---|---|---|---|---|---|---|
| | | | | Scratch test | ness | |
| Ex. | Type of | Model | Type of | (1 = best, | pen | Bright- |
| No. | lacquer | No. | modification | 6 = worst) | (N) | ness |
| 1 | Epoxy | | Non-modified | | 0.2 | |
| 1 | Epoxy | 2 | Si/Al | | >1 | |
| 2 | Acrylic | | Non-modified | 3 | | 1793 |
| 2 | Acrylic | 2 | Ti | 2 | | 1773 |

TABLE 3
Characterization of various types of lacquers prior to and
after their modification according to model No. 3.

| | | | | Scratch | Taber | |
|---|---|---|---|---|---|---|
| | | | | test | abraser | |
| Ex. | Type of | Model | Type of | ( 1 = best, | Weight | Bright- |
| No. | lacquer | No. | modiflcaiion | 6 = worst) | loss | ness |
| 5 | Acrylic | | Non-modified | | −** | |
| 5 | Acrylic | 3 | Ti | | +** | |
| 6 | Epoxy | | Non-modified | | −** | |
| 6 | Epoxy | 3 | Al | | +** | |
| 7 | Acrylic | | Non-modified | 3 | 1693 | |
| 7 | Acrylic | 3 | Ti | 1 | 1727 | |

The results from the various tests show that lacquer systems with a high wear resistance are achieved through the modification according to (any one of) the three embodiments of the method according to the invention, while the brightness of the lacquer is maintained.

It is emphasized (at the present invention largely is related to modification of existing, commercial lacquers/varnishes, but is not exclusively limited to such products. The invention is thus applicable to other lacquer/varnishes, e.g. special lacquers that have not earlier been commercially available and new lacquers or varnishes that may possible constitute separate invention per se., etc.

Furthermore, we have for simplicity described modifications of lacquers/varnishes that are ready for use. In a commercial situation it may very well be more convenient to perform the modification by introducing the nano-particles as another step of the process than the very last one.

Still further, we have described the process in a manner in which the lacquer/varnish each time receives an amount of particles corresponding to a relevant field of use. It is also possible to add higher concentrations of particles, in which case the user immediately prior to application will dilute the concentrate with a standard lacquer/varnish of the same type to the desired concentration, which in addition may vary according to wear intensity, the substrate to which it is applied etc.

Finally, in connection with the method of manufacturing a lacquer according to the invention, the three alternative methods are described in a way that they may be perceived as being mutually exclusive in any practical situation, so that if model 1 is chosen, model 2 and 3 are automatically discarded for that particular application. This is however, not correct, as it is fully possible to combine the three models. For example a system may be applied in which a finely dispersed powder (model No. 3) is added, while simultaneously producing other inorganic particles from a particle dispersion according to model No. 1 or by in-situ formation in the lacquer according to model No. 2 of the invention.

Said variations are all within the scope of the invention, as are any other modification that a skilled professional might introduce in order to adapt the spirit of the invention to relevant areas of use.

1. Rolled metal substrate of aluminium, aluminium alloys or steel with a layer or coating of an organic based curable and preferably clear and glossy lacquer/varnish, characterized in that the coating or layer is obtainable through a process comprising the following steps:
(first) preparing a sol (particle dispersion) by partial hydrolysis of a solution containing one or more inorganic monomer compounds chosen among the following groups:
i) M(OR)ₙ, or ii) R′-M(OR)ₙ, where M is a metal ion and R an organic group chosen among alkyl, alkenyl, aryl or combinations of such groups with from 1 to 8 carbon atoms, R′═R or R—X, where X is an organic group like e.g. amine, carboxyl or isocyanate., and n is an integer between 1 and 6,
whereafter said sol is mixed with the base lacquer/varnish or gel-coat in such a way and in dependence of the base lacquer/varnish or gel-coat in question that the inorganic polymer particles become dispersed as particles with a particle size in the area 1-100 nm, while said particles through a process of condensation are able to form a three dimensional network principally independent of the network of the lacquer/varnish or gel-coat.

2. Rolled metal substrate of aluminium, aluminium alloys or steel with a layer or coating of an organic based and preferably clear and glossy lacquer/varnish, characterized in that the coating or layer is obtainable through a process comprising the following steps:
a controlled amount of a solution of inorganic monomer compounds is added to a base lacquer/varnish or gel-coat, said inorganic monomer compounds being chosen among the following groups: i) M(OR)ₙ, or ii) R′-M(OR)ₙ,
where M is a metal ion, and R is an organic group chosen among alkyl, alkenyl, aryl or combinations of such groups with from 1 to 8 carbon atoms, R′═R or R—X, where X is an organic group like e.g. amine, carboxyl or isocyanate, and n is an integer between 1 and 6, so that these compounds is able to undergo a combination of a hydrolysis and a condensation reaction under in-situ formation of a three-dimensional network that is principally independent of the network of the lacquer/varnish or gel-coat, while the kinetics of the combined hydrolysis and condensation, varying with the type of resin, cross-linker and solvents, is controlled so that the inorganic polymer particles are formed in the size of oligomers, i.e. mainly with a particle size in the range 1-100 nm.

3. Rolled metal substrate as claimed in claim 1,
characterized in that the solvent is at least partially removed from the sol prior to it being mixed with the base lacquer/varnish or gel-coat.

4. Rolled metal substrate as claimed in any one of the preceding claims,
characterized in that said particles are subjected to a surface modification through a treatment comprising adsorption of polymers, reaction with a silane, a zirconate, a zircoaluminate, an orthothianate, an aluminate or a combination of such treatments.

5. Rolled metal substrate as claimed in claims 1-2,
characterized in that R is a group with up to four carbon atoms, particularly methyl, ethyl, propyl, butyl or a combination of these groups.

6. Rolled metal substrate as claimed in claims 1-2,
characterized in that the metal ion M is chosen from the group consisting of zirconium, aluminium, titanium, silicon or combinations of these metals.

7. Rolled metal substrate as claimed in claim 1,
characterized in that said inorganic polymer particles have a size less than 30 nm.

8. Rolled metal substrate as claimed in claim 1,
characterized in that said inorganic polymer particles are present in a cured lacquer/varnish in an amount of 0.5-50% by weight.

9. Rolled metal substrate as claimed in claim 1,
characterized in that the thickness of said layer is in the magnitude of 1-10 μm.

10. Utilization of organic based curable and preferably clear and glossy lacquer/varnish comprising a controlled amount of inorganic polymer particles with a particle size mainly in the range 1-100 nm, said particles being reaction products resulting from hydrolysis and condensation reactions of monomer compounds chosen among the following groups:
i) M(OR)ₙ, or ii) R′-M(OR)ₙ
where M is a metal ion and R an organic group chosen among alkyl, alkenyl, aryl or combinations of these with from 1 to 8 carbon atoms, R′═R or R—X, where X is an organic group like e.g. amine, carboxyl or isocyanate, and where n is an integer between 1 and 6, for coil-coating of rolled surfaces of aluminium, aluminium alloys or steel.

11. Utilization as claimed in claim 10, said metal ion M being zirconium, aluminium, titanium, silicon or a combination of these metals.

12. Utilization as claimed in claim 10, R being a group with up to four carbon atoms, particularly methyl, ethyl, propyl, butyl or a combination of these groups.

13. Utilization as claimed in claim 10, said inorganic polymer particles having a size less than 30 nm.

14. Utilization as claimed in claim 10, said inorganic polymer particles being present in a cured lacquer/varnish in an amount of 0.5-50% by weight calculated on the basis of non-hardened lacquer/varnish.
